(19) United States
(12) Patent Application Publication
(10) Pub. No.: US 2025/0167267 A1
(43) Pub. Date: May 22, 2025

(54) HYBRID SYSTEM FOR GENERATING HYDROGEN AND A METHOD OF CONTROLLING THE SAME

(71) Applicants: HYUNDAI MOTOR COMPANY, Seoul (KR); KIA CORPORATION, Seoul (KR)

(72) Inventors: Jaeyong Lee, Seongnam-si (KR); Ji-Hoon Jang, Suwon-si (KR); Jihui Seo, Ulsan (KR); Hanjin Kim, Seoul (KR); Pyung Soon Kim, Suwon-si (KR); Jihye Park, Seoul (KR)

(73) Assignees: HYUNDAI MOTOR COMPANY, Seoul (KR); KIA CORPORATION, Seoul (KR)

(21) Appl. No.: 18/635,832

(22) Filed: Apr. 15, 2024

(30) Foreign Application Priority Data
Nov. 22, 2023 (KR) 10-2023-0162948

(51) Int. Cl. H01M 8/04082; C01B 3/06; H01M 8/04746

(52) U.S. Cl. CPC H01M 8/04201; C01B 3/065; H01M 8/04753

(57) ABSTRACT

A hybrid system for generating hydrogen according to an embodiment may include: a compressed hydrogen supply system configured to store compressed hydrogen gas supplied from an external hydrogen charging station, and selectively supply the hydrogen gas to a fuel cell; and a solid hydrogen supply system configured to generate the hydrogen gas by a chemical reaction of a chemical hydride, and selectively supplying generated hydrogen gas to the fuel cell.

### CROSS-REFERENCE TO RELATED APPLICATION

This application claims priority to and the benefit of Korean Patent Application No. 10-2023-0162948 filed on Nov. 22, 2023, the entire contents of which are incorporated herein by reference.

### BACKGROUND

### (a) Field

The present disclosure relates to a hybrid system for generating hydrogen and a method of controlling the same. More particularly, the present disclosure relates to a hybrid system for generating hydrogen and a method of controlling the same, which can use both a compressed hydrogen storage system and a solid hydrogen storage system.

### (b) Description of the Related Art

Due to the depletion of fossil energy and environmental pollution, there is a high demand for renewable alternative energy. As a result, hydrogen is attracting attention as one such alternative energy.

Fuel cells and hydrogen combustion devices use hydrogen as reaction gas. A stable continuous supply of hydrogen technology is required to apply the fuel cells and the hydrogen combustion devices to automobiles and various electronic products.

A scheme for receiving hydrogen from a hydrogen charging station, which is separately installed to supply hydrogen to a device whenever the hydrogen is required, may be used (hereinafter, referred to as ‘compressed hydrogen supply scheme’). In such a scheme, compressed hydrogen may be used.

However, a scheme for generating the hydrogen by injecting acid aqueous solutions, acid catalysts, or water and acid catalysts into a solid hydride stored in a dehydrogenation reactor in order to supply the hydrogen to the fuel cell or the hydrogen combustion device may be used (hereinafter, referred to as ‘solid hydrogen supply scheme’).

In the compressed hydrogen supply scheme, before the hydrogen is exhausted, a vehicle moves to an external hydrogen charging station or a mobile hydrogen charging station moves to a vehicle to be charged so that the hydrogen may be supplied to the vehicle. Therefore, when the hydrogen is exhausted, the vehicle must move to the hydrogen charging station to recharge the hydrogen.

In the solid hydrogen supply scheme, when solid hydride reacts at room temperature/room pressure, a gas of impurities is likely to be mixed in an initial reaction, and vaporized gas including water vapor may also be included due to a heating reaction. Thus, in addition to pure hydrogen gas, impurities and/or water vapor can be supplied to the fuel cells or hydrogen combustion devices, which can adversely affect the durability of the fuel cells or hydrogen combustion devices.

The above information disclosed in this Background section is only to enhance understanding of the background of the present disclosure. Therefore, the Background section may contain information that does not form the prior art that is already known to a person of ordinary skill in the art.

### SUMMARY

The present disclosure provides a hybrid system for generating hydrogen and a method of controlling the same, which can use a compressed hydrogen supply scheme and a solid hydrogen supply scheme.

In an embodiment of the present disclosure, a hybrid system for generating hydrogen may include: a compressed hydrogen supply system configured to store compressed hydrogen gas supplied from an external hydrogen charging station, and selectively supply the compressed hydrogen gas to a fuel cell. The hybrid system further includes a solid hydrogen supply system configured to generate the hydrogen gas by a chemical reaction of a chemical hydride, and selectively supply the generated hydrogen gas to the fuel cell.

In some embodiments, the compressed hydrogen supply system may include: at least one compressed hydrogen tank configured to store the compressed hydrogen gas, and a first pressure regulator provided downstream of the compressed hydrogen tank.

In some embodiments, the solid hydrogen supply system may include: an acid aqueous solution tank configured to store an acid aqueous solution, and at least one dehydrogenation reactor configured to store the chemical hydride, and selectively receive the acid aqueous solution stored in the acid aqueous solution tank to generate hydrogen gas. The solid hydrogen supply system may also include a heat regulation device configured to regulate a temperature of the dehydrogenation reactor.

In some embodiments, the solid hydrogen supply system may further include a purging device configured to discharge impurity gas inside the dehydrogenation reactor.

In some embodiments, the purging device may include: a first purging pipe configured to fluidly connect the compressed hydrogen tank and the dehydrogenation reactor; and a second purging pipe configured to fluidly connect the dehydrogenation reactor and the outside. The purging device may also include: a first purging valve provided in the first purging pipe between the compressed hydrogen tank and the dehydrogenation reactor; and a second purging valve provided in the second purging pipe downstream of the dehydrogenation reactor.

In some embodiments, the purging device may further include a vacuum pump provided in the second purging pipe downstream of the second purging valve.

In some embodiments, the hybrid system may further include a buffer tank configured to temporarily store the hydrogen gas generated by the dehydrogenation reactor.

In some embodiments, the hybrid system may further include booster pump provided between the buffer tank and the compressed hydrogen tank.

In some embodiments, the buffer tank may be the compressed hydrogen tank of the compressed hydrogen supply system.

In some embodiments, the solid hydrogen supply system may further include: a back pressure regulator provided upstream of the buffer tank; a rectification device for the hydrogen gas provided upstream of the back pressure regulator; and a second pressure regulator provided downstream of the buffer tank.

Another embodiment of the present disclosure provides a hybrid method for generating hydrogen using a compressed hydrogen supply system and a solid hydrogen supply system. The hybrid method may include: performing a first mode in which hydrogen gas is supplied from the compressed hydrogen supply system to a fuel cell when a first condition is satisfied; and performing a second mode in which the hydrogen gas is supplied from the solid hydrogen supply system to the fuel cell when a second condition is satisfied. The method may further include performing a third mode in which the hydrogen gas is supplied to the fuel cell from both the solid hydrogen supply system and the compressed hydrogen supply system when a third condition is satisfied

In some embodiments, the first condition may be satisfied when all of the reactants of the dehydrogenation reactor in the solid hydrogen supply system are exhausted. Alternatively, the first condition may be satisfied when the hydrogen gas amount stored in the compressed hydrogen tank of the compressed hydrogen supply system is less than a set amount and a storage capacity of the compressed hydrogen tank is equal to or more than a total hydrogen gas generation amount in the solid hydrogen supply system.

In some embodiments, the second condition may be satisfied: when the hydrogen gas stored in the compressed hydrogen tank of the compressed hydrogen supply system is completely exhausted; when the hydrogen gas amount generated by the solid hydrogen supply system does not satisfy the hydrogen gas amount required by the fuel cell, or when a storage capacity of the buffer tank of the solid hydrogen supply system is equal to or more than a total hydrogen gas generation amount in the dehydrogenation reactor.

In some embodiments, the third condition may be satisfied when: a flow rate of the hydrogen gas generated by the dehydrogenation reactor of the solid hydrogen supply system deviates from a set range, the storage capacity of the buffer tank of the solid hydrogen supply system is less than the total hydrogen gas generation amount generated by the dehydrogenation reactor of the solid hydrogen supply system; or a time required for raising a pressure of the hydrogen gas stored in the buffer tank to be equal to or more than a set pressure of the pressure regulator is equal to or more than a set time.

In some embodiments, the first mode may include supplying the hydrogen gas stored in the compressed hydrogen tank of the compressed hydrogen supply system to the fuel cell. Additionally, the first mode may include supplying the hydrogen gas from the solid hydrogen supply system to the fuel cell when an internal pressure of the compressed hydrogen tank is less than a set pressure.

In some embodiments, the second mode may include performing a purging process of a dehydrogenation reactor of the solid hydrogen supply system when a purging condition is satisfied. Additionally, the second mode may include: supplying the hydrogen gas from the solid hydrogen supply system to the fuel cell; and supplying the hydrogen gas from the compressed hydrogen tank of the compressed hydrogen supply system to the fuel cell when an internal pressure of the dehydrogenation reactor is less than a set pressure

In some embodiments, the performing of the purging process may include: supplying the hydrogen gas stored in the compressed hydrogen tank of the compressed hydrogen supply system to the dehydrogenation reactor of the solid hydrogen supply system; and discharging a mixed gas having the impurity gas of the dehydrogenation reactor and the hydrogen gas to the outside.

In some embodiments, the third mode may include performing the purging process of the dehydrogenation reactor of the solid hydrogen supply system when a purging mode is satisfied. The third mode may also include: supplying the hydrogen gas from the solid hydrogen supply system to the fuel cell; and supplying the hydrogen gas stored in the compressed hydrogen tank of the compressed hydrogen supply system to the fuel cell when a pressure of the hydrogen gas stored in the buffer tank of the solid hydrogen supply system is lower than a set pressure of a pressure regulator provided downstream of the buffer tank. Additionally, the third mode may include supplying the hydrogen gas from the solid hydrogen supply system to the fuel cell when the pressure of the hydrogen gas stored in the buffer tank is higher than the set pressure of the pressure regulator provided downstream of the buffer tank.

In some embodiments, the performing of the purging process may include supplying the hydrogen gas stored in the compressed hydrogen tank of the compressed hydrogen supply system to the dehydrogenation reactor of the solid hydrogen supply system, and discharging a mixed gas having the impurity gas of the dehydrogenation reactor and the hydrogen gas to the outside.

According to the embodiments, hydrogen gas is supplied to a fuel cell through a compressed hydrogen supply system and a solid hydrogen supply system to stably supply the hydrogen gas to the fuel cell even when there is an emergency situation in the compressed hydrogen supply system or the solid hydrogen supply system.

In addition, generation of impurity gas can be minimized through a purging process of a dehydrogenation reactor.

Additionally, an effect which can be obtained or predicted by the embodiments of the present disclosure is directly or implicitly disclosed in the detailed description of the embodiments of the present disclosure. In other words, various effects predicted according to the embodiments of the present disclosure are disclosed in the detailed description described below.

### BRIEF DESCRIPTION OF THE DRAWINGS

These drawings are for the purpose of describing an embodiment of the present disclosure, and therefore the technical spirit of the present disclosure should not be construed as being limited to the accompanying drawings.

FIG. 1 is a circuit diagram illustrating a configuration of a hybrid system for generating hydrogen according to an embodiment.

FIG. 2 is a block diagram illustrating a configuration of a hybrid system for generating hydrogen according to an embodiment.

FIGS. 3-6 are flowcharts illustrating a method of controlling a hybrid system for generating hydrogen according to an embodiment.

The drawings referenced above are not particularly drawn to scale, but should be understood as presenting a somewhat brief expression of various features that illustrate the basic principles of the present disclosure. For example, the specific design features of the present disclosure, including specific dimensions, directions, positions, and shapes, should be partially determined by specific intended applications and use environments.

### DETAILED DESCRIPTION

The terms used herein are only for describing specific embodiments, and are not intended to limit the present disclosure. As used herein, the singular forms are also intended to include plural forms, unless they are explicitly indicated differently by context. It should be appreciated that when terms “include” and/or “including” are used in the present disclosure, the terms “include” and/or “including” are intended to designate the existence of mentioned features, integers, steps, operations, constituent elements, and/or components. However, the terms do not exclude the existence or addition of one or more other features, integers, steps, operations, constituent elements, components, and/or groups thereof. As used herein, the terms “and/or” include any one or all combinations of the items which are associated and listed.

Additionally, it should be appreciated that one or more of the following methods or aspects thereof can be executed by one or more controllers. The term “controller” may refer to a hardware device including a memory and a processor. The memory is configured to store program instructions, and the processor is particularly programmed to execute the program instructions in order to perform one or more processes which are described below in more detail. As disclosed herein, the controller may control units, modules, parts, devices, or operations of those similar thereto. Further, as recognized by those having ordinary skill in the art, it should be appreciated that the following methods may be executed by a device including the controller jointly with one or more other components.

Further, the controller of the present disclosure may be implemented as a non-transitory computer-readable recording medium including executable program instructions executed by the processor. Examples of computer-readable recording media include a read-only memory (ROM), a random access memory (RAM), a compact disk (CD) ROM, magnetic tapes, floppy disks, flash drives, smart cards, and optical data storage devices, but are not limited thereto. The computer-readable recording media are also distributed throughout a computer network, and program instructions may be stored and executed by a distribution scheme such as a telematics server or a controller area network (CAN).

The present disclosure is described in detail so as to be easily carried out by those having ordinary skill in the art in a technical field to which the present disclosure pertains. However, the present disclosure can be realized in various different forms and is not limited to the embodiments described herein.

Parts irrelevant to the description have been omitted to clearly describe the present disclosure and the same elements have been designated by the same reference numerals throughout the present disclosure.

Further, since the size and thickness of each component illustrated in the drawings are arbitrarily represented for convenience in explanation, the present disclosure is not particularly limited to the illustrated size and thickness of each component. Additionally, the thickness is enlarged and illustrated in order to clearly express various parts and areas.

Suffixes such as “module” and/or “unit” for components used in the following present disclosure are given or mixed in consideration to ease understanding of the present disclosure and do not have their own distinguished meanings or roles.

Further, in describing a disclosed embodiment, a detailed description of related known technologies has been omitted when it was determined that the detailed description made the gist of the embodiment of the present disclosure unclear.

Further, the accompanying drawings are provided to easily help understand the embodiments disclosed in the present disclosure, and the technical spirit disclosed in the present disclosure is not limited by the accompanying drawings. It should be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms.

In the description below, the expression described by the singular can be interpreted as a singular or plurality, unless an explicit expression such as “one” or “single” is used.

The terms are used only to discriminate one component from another component.

In a flowchart described with reference to the drawings, the order of operations may be changed, multiple operations may be merged, or any operation may be divided, and a specific operation may not be performed.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, a hybrid system for generating hydrogen according to an embodiment is described in detail with reference to the accompanying drawings.

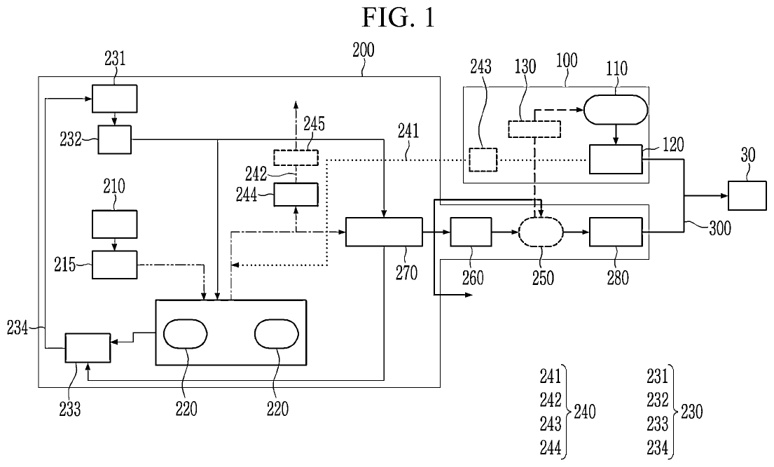

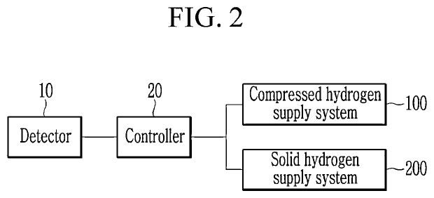

FIG. 1 is a circuit diagram illustrating a configuration of a hybrid system for generating hydrogen according to an embodiment.

As illustrated in FIG. 1, the hybrid system for generating hydrogen according to an embodiment may include a compressed hydrogen supply system 100 and a solid hydrogen supply system 200.

The compressed hydrogen supply system 100 may store hydrogen gas supplied from an external hydrogen charging station (not illustrated), and supply the hydrogen gas to a fuel cell 30.

The compressed hydrogen supply system 100 may store compressed hydrogen gas supplied from the external hydrogen charging station, and selectively supply the stored compressed hydrogen gas to the fuel cell 30. The solid hydrogen supply system 200 may generate hydrogen gas by a chemical reaction of a chemical hydride, and selectively supply the generated hydrogen gas to the fuel cell 30. The hydrogen gas discharged from the compressed hydrogen supply system 100 and the hydrogen gas discharged from the solid hydrogen supply system 200 may be fluidly connected through a discharge pipe 300. The hydrogen gas which flows via the discharge pipe 300 may be supplied to the fuel cell 30.

The compressed hydrogen supply system 100 may include at least one compressed hydrogen tank 110 and a first pressure regulator 120.

The compressed hydrogen tank 110 may receive the hydrogen gas from an external charging station (not illustrated), and temporarily store the received hydrogen gas. The stored hydrogen gas may be selectively supplied to the fuel cell 30.

The first pressure regulator 120 may be provided downstream of the compressed hydrogen tank 110, and regulate a pressure of the hydrogen gas supplied from the compressed hydrogen tank 110 to the fuel cell 30. When an internal pressure of the compressed hydrogen tank 110 is less than a set pressure of the first pressure regulator 120, the hydrogen gas stored in the compressed hydrogen tank 110 is not supplied to the fuel cell 30. When the internal pressure of the compressed hydrogen tank 110 is larger than the set pressure of the first pressure regulator 120, the pressure of the hydrogen gas stored in the compressed hydrogen tank 110 is lowered to the set pressure of the first pressure regulator 120. Then the hydrogen gas is supplied to the fuel cell 30.

The solid hydrogen supply system 200 may generate the hydrogen gas by the chemical reaction of a chemical hydride (hereinafter, referred to as ‘reactant’ as needed), and the generated hydrogen gas may be selectively supplied to the fuel cell 30.

To this end, the solid hydrogen supply system may include an acid aqueous solution tank 210, at least one dehydrogenation reactor 220, a heat regulation device 230, and a buffer tank 250.

The acid aqueous solution tank 210 may store an acid aqueous solution, and the stored acid aqueous solution may be selectively supplied to the dehydrogenation reactor 220. An aqueous solution pump may be provided between the acid aqueous solution tank 210 and the dehydrogenation reactor 220. The acid aqueous solution stored in the acid aqueous solution tank may be pumped through the aqueous solution pump, and supplied to the dehydrogenation reactor 220.

The acid aqueous solution tank 210 may have a corrosion-resistant protective film such as Teflon coating in order to prevent corrosion by the acid aqueous solution. The acid aqueous solution shortens a half-life by regulating a pH of the chemical hydride to promote the dehydrogenation reaction.

Acids may be inorganic acids such as sulfuric acid, nitrate, phosphoric acid, boric acid, or hydrochloric acid. Acids may also be organic acids such as heteropolic acid, acetic acid, formic acid, malikic acid, citrate, tartaric acid, ascovic acid, lactic acid, oxalic acid, suksin acid, taurine acid, or a mixture thereof. A molecular weight is less than hydrogen ions, which can reduce the weight of the system, and formic acid (HCOOH) may be used in that the phosphoric acid is safer than hydrochloric acid in a high concentration state.

The phosphoric acid, as weak acid, may be maintained at a low pH at a set condition, and comparatively safely used. In addition, the collected carbon dioxide may be obtained through hydrogenation, which is an important substance in terms of recycling/recirculation of carbon dioxide. In addition, formate is converted to bicarbonate through the dehydrogenation reaction, which may further obtain hydrogen.

The dehydrogenation reactor 220 may generate the hydrogen gas by the chemical reaction of the chemical hydride and the acid aqueous solution.

The dehydrogenation reactor 220 may be constituted by a high-temperature and high-pressure container so that the dehydrogenation reaction may be achieved under a high-temperature and high-pressure condition. As an example, the dehydrogenation reactor 220 may have a cylindrical, spherical, rectangular parallelepiped, or polygonal pillar shape. In particular, the dehydrogenation reactor 220 may have a cylindrical shape.

The chemical hydride as a solid state may be, as an example, any one type of powder, granular, bead, microcapsule, and pellets.

The chemical hydride may be any compound which is hydrolyzed, and generates hydrogen and hydrolysate, and may include, as an example, Sodium borohydride (NaBH4), lithium borohydride (LiBH4), potassium borohydride (KBH4), ammonium borohydride (NH4BH4), ammonia borane (NH3BH3), tetramethylammonium borohydride ((CH3)4NH4BH4), sodium aluminum hydride (NaAIH4), lithium aluminum hydride (LiAIH4), potassium aluminum hydride (KAIH4), calcium borohydride (Ca(BH4)2), magnesium borohydride (Mg(BH4)2), sodium gallium hydride (NaGaH4), lithium gallium hydride (LiGaH4), potassium gallium hydride (KGaH4), lithium hydride (LiH), calcium hydride (CaH2), magnesium hydride (MgH2), or a mixture thereof.

Since the hydrogen generation reaction inside the dehydrogenation reactor 220 is a heating reaction, the heat regulation device 230 is provided in order to cool the reaction heat.

The heat regulation device 230 may include a reservoir tank 231 storing a heating medium, and a cooling pump 232 pumping the heat medium stored in the reservoir tank 231 and supplying the pumped heat medium to the dehydrogenation reactor 220. The heat regulation device 230 may also include a heat exchanger 233 for cooling the heat medium heated by the dehydrogenation reactor 220.

The reservoir tank 231, the cooling pump 232, the dehydrogenation reactor 220, and the heat exchanger 233 are fluidly connected through a cooling pipe 234 in which the heat medium flows. The heat medium stored in the reservoir tank 231 circulates in the cooling pump 232, the dehydrogenation reactor 220, and the heat exchanger 233, and flows back into the reservoir tank 231.

The heat medium which flows via the cooling pipe 234 may include at least any one of an aqueous liquid refrigerant, an oil liquid refrigerant, a fluorine-based gas refrigerant, and an inorganic compound-based gas refrigerant.

The cooling pump 232 may be an electric water pump (EWP) pumping the heat medium by power.

The heat exchanger 233 may be an air-cooled or water-cooled radiator, or a plate type heat exchanger 233. As needed, the heat exchanger 233 may be used commonly with an air-conditioner compressor provided in the vehicle.

The hydrogen gas generated by the dehydrogenation reactor 220 may be temporarily stored in the buffer tank 250. A separate buffer tank 250 is not provided in the solid hydrogen supply system 200, and instead the buffer tank 250 may be replaced with the compressed hydrogen tank 110 of the compressed hydrogen supply system 100. When the dehydrogenation reactor 220 is replaced, residual hydrogen gas stored in the buffer tank 250 may be discharged to the outside.

A back pressure regulator 260 may be provided between the dehydrogenation reactor 220 and the buffer tank 250 (or downstream of the dehydrogenation reactor 220). In addition, a second pressure regulator 280 may be provided downstream of the buffer tank 250. When an internal pressure of the buffer tank 250 is less than a set pressure of the second pressure regulator 280, the hydrogen gas stored in the buffer tank 250 is not supplied to the fuel cell 30. When the pressure of the hydrogen gas stored in the buffer tank 250 is raised to the set pressure of the second pressure regulator 280, the hydrogen gas is supplied to the fuel cell 30.

In order to stably extract the hydrogen from the dehydrogenation reactor 220, a boiling point (100° C. to 400° C.) of the reactant is regulated by raising an internal pressure of a reaction container of the dehydrogenation reactor 220 to a specific pressure (e.g., 1 to 350 bar) to minimize a phase change of the reactant. To this end, the back pressure regulator 260 and the second pressure regulator 280 are disposed downstream of the dehydrogenation reactor 220 to regulate the internal pressure of the reaction container of the dehydrogenation reactor 220.

In this case, the hydrogen generated from the inside of the reaction container of the dehydrogenation reactor 220 may be temporarily stored in the buffer tank 250 at a pressure which is almost the same as the internal pressure of the reaction container of the dehydrogenation reactor 220 by the back pressure regulator 260 until the second pressure regulator 280 is opened in order to extract the hydrogen from the buffer tank 250. Accordingly, the hydrogen gas may be stored in the buffer tank 250 at a pressure similar to the internal pressure of the dehydrogenation reactor 220 without a need of applying separate energy.

A rectification device 270 may be provided between the dehydrogenation reactor 220 and the buffer tank 250 (or downstream of the dehydrogenation reactor 220), which removes impurities generated from the inside of the dehydrogenation reactor 220.

When the hydride and the acid aqueous solution react with each other in the dehydrogenation reactor 220, carbon monoxide and moisture may be generated as a by-product. When the carbon monoxide and the moisture generated as the by-product are supplied to the fuel cell 30, the durability of the fuel cell 30 may be deteriorated.

The rectification device 270 may include a methane generator (not illustrated) for removing the carbon monoxide included in the hydrogen gas, and/or a gas/liquid separator (not illustrated) for removing the moisture.

The methane generator converts the carbon monoxide generated as the by-product into methane when the hydrogen is generated by the dehydrogenation reaction of the hydride and the acid aqueous solution inside the dehydrogenation reactor 220. In the methane generator, the carbon monoxide is converted into methane while gas of the hydrogen and the carbon monoxide discharged from the dehydrogenation reactor 220 pass through a catalyst. The catalyst of the methane generator may include at least one of nickel (NI), rutenium (Ru), cobalt (Co), rhodium (RH), and iron (Fe). The catalyst in a solid state may be, as an example, any one type of granular, bead, microcapsule, and pellets.

The gas/liquid separator may separate an excessive amount of moisture included in the hydrogen gas.

When the hydride is recharged in the dehydrogenation reactor 220, external air may flow into the dehydrogenation reactor 220. Alternatively, a set amount of product may be generated in the dehydrogenation reactor 220, and the impurity gas may flow into the dehydrogenation reactor 220 when re-reaction is achieved.

As such, when external air flows into the dehydrogenation reactor 220, a condition may be formed in which the impurity gas such as carbon monoxide is easily generated in addition to the hydrogen gas due to any overheat generated from the inside of the dehydrogenation reactor 220. Thus, there may be a problem in that it is difficult to generate pure hydrogen gas by the impurity gas which flows into the dehydrogenation reactor 220.

In order to prevent such a problem, the hybrid system for generating hydrogen according to an embodiment may be provided with a purging device 240 for discharging the impurity gas inside the dehydrogenation reactor 220 to the outside. The purging device 240 may discharge the impurity gas inside the dehydrogenation reactor 220 to the outside through the hydrogen gas at the set pressure or more, or discharge the impurity gas inside the dehydrogenation reactor 220 to the outside through a vacuum pump 245.

To this end, the purging device 240 may include a first purging pipe 241 fluidly connecting the compressed hydrogen tank 110 of the compressed hydrogen supply system 100 and the dehydrogenation reactor 220 of the solid hydrogen supply system 200. The purging device 240 may also include: a second purging pipe 242 fluidly connecting the dehydrogenation reactor 220 and the outside; a first purging valve 243 provided in the first purging pipe 241 between the compressed hydrogen tank 110 and the dehydrogenation reactor 220; and a second purging valve 244 provided in the second purging pipe 242 downstream of the dehydrogenation reactor 220. As needed, the vacuum pump 245 may be provided in the purging pipe downstream of the second purging valve 244.

The first purging valve 243 may include a solenoid valve and/or a third pressure regulator.

When purging is required in the dehydrogenation reactor 220 (e.g., the hydride is recharged in the dehydrogenation reactor 220), pure hydrogen gas at the room pressure or more, which is stored in the compressed hydrogen tank 110 is supplied to the dehydrogenation reactor 220 through the first purging pipe 241 to purge the inside of the dehydrogenation reactor 220 with the pure hydrogen gas. The purging process may be performed for a time (e.g., 1 second to 1 minute) for which the internal pressure of the dehydrogenation reactor 220 is set to room pressure or more.

Mixing gas in which the impurity gas (e.g., the external air, and the like) inside the dehydrogenation reactor 220 of the solid hydrogen supply system 200 and the hydrogen gas are mixed is discharged to the outside through the second purging pipe 242 by the purging process.

When the dehydrogenation reactor 220 is pressurized with the hydrogen gas after the purging process, the dehydrogenation reactor 220 may be pressurized at a set pressure (e.g., 2 bar) or more.

When there is no sufficient hydrogen gas to purge the dehydrogenation reactor 220 inside the compressed hydrogen tank 110, the inside of the dehydrogenation reactor 220 may be purged using the vacuum pump 245.

A booster pump 130 may be provided between the buffer tank 250 and the compressed hydrogen tank 110. The booster pump 130 may pressurize the hydrogen gas stored in the buffer tank 250, and supply the pressurized hydrogen gas to the compressed hydrogen tank 110. As a result, the hydrogen gas stored in the buffer tank 250 may be stored in the compressed hydrogen tank 110 at a pressure equal to or more than the reaction pressure in the dehydrogenation reactor 220 through the booster pump 130.

Further, a fourth pressure regulator (not illustrated) may be provided downstream of the first pressure regulator 120 and the second pressure regulator 280.

The hybrid system for generating hydrogen according to an embodiment may include a controller 20 controlling each component of the hybrid system for generating hydrogen based on operating information detected by the detector 10.

The controller 20 may be implemented as one or more processors which are operated by a set program. A memory of the controller 20 stores program instructions programmed to perform each step of a hybrid method for generating hydrogen according to an embodiment through the one or more processors.

The controller 20 may control operations of the compressed hydrogen supply system 100 and the solid hydrogen supply system 200.

The detector 10 may include: a first flow sensor (not illustrated) measuring the amount of a reactant of the dehydrogenation reactor 220; a second flow sensor (not illustrated) measuring a hydrogen gas amount stored in the compressed hydrogen tank 110; and a first pressure sensor (not illustrated) measuring a pressure of hydrogen gas stored in the compressed hydrogen tank 110. The detector 10 may also include: a third flow sensor (not illustrated) measuring a hydrogen gas amount stored in the buffer tank 250; a second pressure sensor (not illustrated) measuring a pressure of hydrogen gas stored in the buffer tank 250; a fourth flow sensor (not illustrated) measuring a flow rate of hydrogen gas generated by the dehydrogenation reactor 220; and a third pressure sensor (not illustrated) measuring an internal pressure of the dehydrogenation reactor 220.

Hereinafter, an actuation of the hybrid system for generating hydrogen according to an embodiment is described in detail with reference to the accompanying drawings.

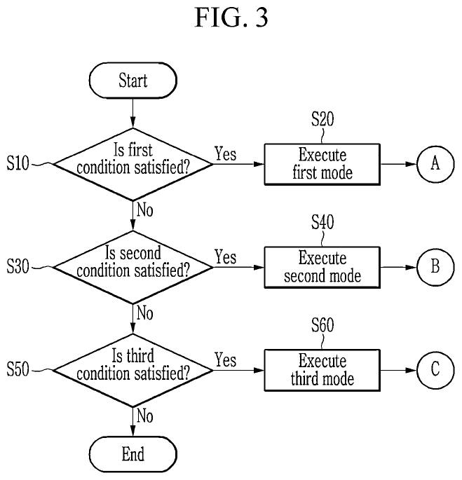

FIG. 3 is a flowchart illustrating a method of controlling a hybrid system for generating hydrogen according to an embodiment.

As illustrated in FIG. 3, the hybrid system for generating hydrogen according to an embodiment may be selectively actuated in any one mode of a first mode, a second mode, and a third mode.

When a first condition is satisfied (S10), the first mode is performed (S20).

The first mode is a mode in which hydrogen gas is preferentially supplied from the compressed hydrogen supply system 100 to the fuel cell 30. When the first condition is satisfied, the hybrid system for generating hydrogen may be actuated in the first mode.

The first condition may be satisfied when the hydrogen gas may not be generated from the solid hydrogen supply system 200 (e.g., all of the reactants of the dehydrogenation reactor 220 are exhausted), or when the hydrogen gas amount stored in the compressed hydrogen tank 110 of the compressed hydrogen supply system 100 is less than a set amount and a storage capacity of the compressed hydrogen tank 110 is equal to or more than a total hydrogen gas generation amount in the solid hydrogen supply system 200.

When a second condition is satisfied (S30), the second mode is performed (S40).

The second mode is a mode in which the hydrogen gas is preferentially supplied from the solid hydrogen supply system 200 to the fuel cell 30. When the second condition is satisfied, the hybrid system for generating hydrogen may be actuated in the second mode.

The second condition may be satisfied when the hydrogen gas stored in the compressed hydrogen tank 110 of the compressed hydrogen supply system 100 is completely exhausted. Alternatively, the second condition may be satisfied when the hydrogen gas amount generated by the solid hydrogen supply system 200 may satisfy the hydrogen gas amount required by the fuel cell 30. The second condition may also be satisfied when a storage capacity of the buffer tank 250 of the solid hydrogen supply system 200 is equal to or more than a total hydrogen gas generation amount in the dehydrogenation reactor 220.

When a third condition is satisfied (S50), the third mode is performed (S60).

In addition, the third mode is a mode in which while the hydrogen gas of the compressed hydrogen supply system 100 and the hydrogen gas of the solid hydrogen supply system 200 cross each other, thus supplying the hydrogen gas to the fuel cell 30. When the third condition is satisfied, the hybrid system for generating hydrogen may be actuated in the third mode.

The third condition may be satisfied when a flow rate of the hydrogen gas generated by the dehydrogenation reactor 220 of the solid hydrogen supply system 200 deviates from a set range (e.g., when the flow rate of the hydrogen gas generated by the dehydrogenation reactor 220 is not constant). Alternatively, the third condition may be satisfied when the storage capacity of the buffer tank 250 of the solid hydrogen supply system 200 is less than the total hydrogen gas amount generated by the dehydrogenation reactor 220 of the solid hydrogen supply system 200. This occurs when a time required for raising a pressure of the hydrogen gas stored in the buffer tank 250 to be equal to or more than a set pressure of the second pressure regulator 280 is equal to or more than a set time (i.e., a period of time required to raise an internal pressure of the buffer tank 250 to be equal to or more than the set pressure of the second pressure regulator 280).

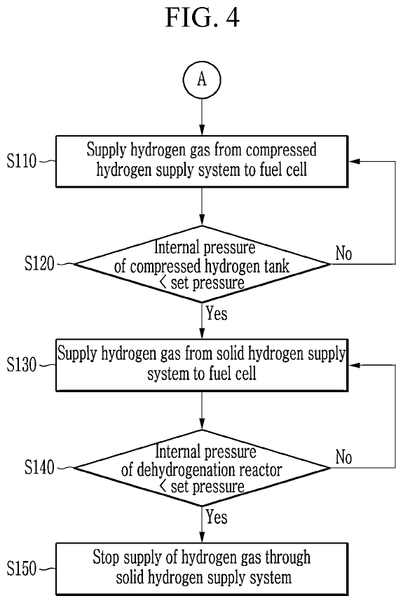

Referring to FIG. 4, when the first mode is executed, the hydrogen gas is supplied from the compressed hydrogen supply system 100 to the fuel cell 30. In other words, the hydrogen gas stored in the compressed hydrogen tank 110 is supplied to the fuel cell 30 (S110). In this case, the hydrogen gas is supplied to the fuel cell 30 at the pressure set by the first pressure regulator 120.

The controller 20 determines whether the internal pressure of the compressed hydrogen tank 110 is less than a set pressure (e.g., 16 bar) (S120). When an internal pressure of the compressed hydrogen tank 110 is less than the set pressure, the supply of the hydrogen gas through the compressed hydrogen supply system 100 is stopped, and the hydrogen gas is supplied from the solid pressure hydrogen supply system 200 to the fuel cell 30 (S130).

The controller 20 determines whether an internal pressure of the dehydrogenation reactor 220 is less than a set pressure (S140). When the internal pressure of the dehydrogenation reactor 220 is less than the set pressure, the supply of the hydrogen gas through the solid hydrogen supply system 200 is stopped (S150).

As such, the hydrogen gas stored in the compressed hydrogen tank 110 is preferentially supplied to the fuel cell 30 in the first mode. Thereafter, when the hydrogen gas stored in the compressed hydrogen tank 110 is completely exhausted, the hydrogen gas is supplied to the fuel cell 30 through the solid hydrogen supply system 200.

When the reactant of the dehydrogenation reactor 220 of the solid hydrogen supply system 200 is completely exhausted, the supply of the hydrogen gas to the fuel cell 30 is stopped.

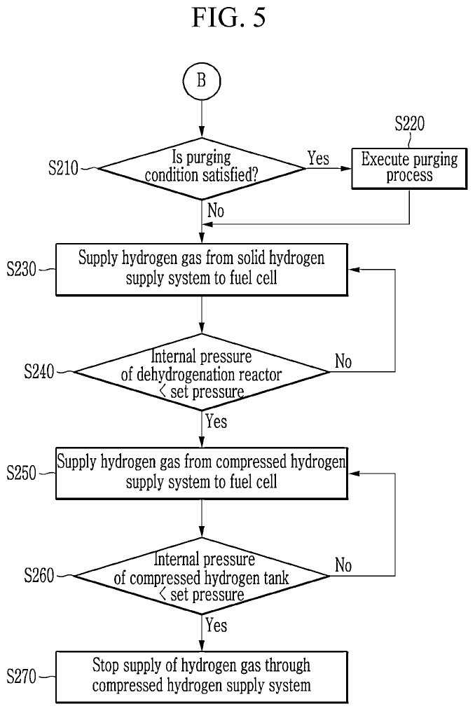

Referring to FIG. 5, when the second mode is performed, the controller 20 determines whether a purging condition is satisfied (S210). The purging condition may be satisfied when the dehydrogenation reactor 220 is replaced.

When the purging condition is satisfied, a purging process of the dehydrogenation reactor 220 is performed (S220).

In this case, a first purging valve 243 is opened, and the hydrogen gas stored in the compressed hydrogen tank 110 is supplied to the dehydrogenation reactor 220 through a first purging pipe 241. When purging of the dehydrogenation reactor 220 is completed, a second purging valve 244 is opened, and a mixed gas of impurity gas and hydrogen gas of the dehydrogenation reactor 220 is discharged to the outside through a second purging pipe 242.

When the hydrogen gas amount stored in the compressed hydrogen tank 110 is less than a set amount (when the hydrogen gas amount is not sufficient to perform the purging process), the second purging valve 244 is opened, and the vacuum pump 245 is actuated. Impurity gas inside the dehydrogenation reactor 220 is discharged to the outside by the actuation of the vacuum pump 245.

The inside of the dehydrogenation reactor 220 is charged at a set pressure or more with the hydrogen gas stored in the compressed hydrogen tank 110 of the compressed hydrogen supply system 100 through the purging process. As a result, the inside of the dehydrogenation reactor 220 is maintained with pure hydrogen gas or in a vacuum state. The pure hydrogen gas may be generated by a chemical reaction of the reactant inside the dehydrogenation reactor 220.

The hydrogen gas is supplied from the solid hydrogen supply system 200 to the fuel cell 30 (S230). In other words, the hydrogen gas is generated by a chemical reaction of a chemical hydride and an acid aqueous solution stored in the dehydrogenation reactor 220, and the generated hydrogen gas is stored in the buffer tank 250. In addition, the hydrogen gas stored in the buffer tank 250 is supplied to the fuel cell 30. In this case, the pressure of the hydrogen gas stored in the buffer tank 250 is decreased according to the set pressure of the second pressure regulator 280 provided downstream of the buffer tank 250, and then the hydrogen gas is supplied to the fuel cell 30.

The controller 20 determines whether the internal pressure of the dehydrogenation reactor 220 is less than the set pressure (S240).

When the internal pressure of the dehydrogenation reactor 220 is less than the set pressure, the supply of the hydrogen gas through the solid hydrogen supply system 200 is stopped. In addition, the hydrogen gas is supplied from the compressed hydrogen supply system 100 to the fuel cell 30. In other words, the hydrogen gas stored in the compressed hydrogen tank 110 of the compressed hydrogen supply system 100 is supplied to the fuel cell 30 (S250).

The controller 20 determines whether the internal pressure of the compressed hydrogen tank 110 is less than the set pressure (S260).

When the internal pressure of the compressed hydrogen tank 110 is less than the set pressure, the supply of the hydrogen gas through the compressed hydrogen supply system 100 is stopped (S270).

In other words, in the second mode, the hydrogen gas generated by the dehydrogenation reactor 220 of the solid hydrogen supply system 200 is preferentially supplied to the fuel cell 30. Thereafter, when generation of the hydrogen gas by the solid hydrogen supply system 200 is terminated, the hydrogen gas is supplied to the fuel cell 30 through the compressed hydrogen supply system 100.

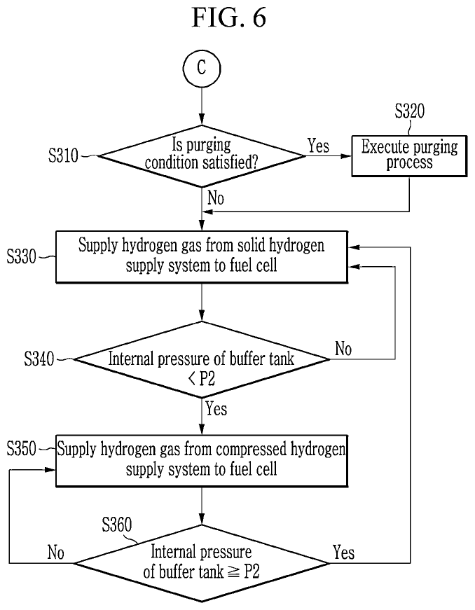

Referring to FIG. 6, when the third mode is performed, the controller 20 determines whether the purging condition is satisfied (S310). The purging condition may be satisfied when the dehydrogenation reactor 220 is replaced.

When the purging condition is satisfied, the purging process of the dehydrogenation reactor 220 is performed (S320).

In this case, a first purging valve 243 is opened, and the hydrogen gas stored in the compressed hydrogen tank 110 is supplied to the dehydrogenation reactor 220 through a first purging pipe 241. When purging of the dehydrogenation reactor 220 is completed, the second purging valve 244 is opened, and the mixed gas of the impurity gas and the hydrogen gas of the dehydrogenation reactor 220 is discharged to the outside through the second purging pipe 242.

When the hydrogen gas amount stored in the compressed hydrogen tank 110 is less than a set amount (when the hydrogen gas amount is not sufficient to perform the purging process), the second purging valve 244 is opened, and the vacuum pump 245 is actuated. The impurity gas inside the dehydrogenation reactor 220 is discharged to the outside by the actuation of the vacuum pump 245.

The inside of the dehydrogenation reactor 220 is charged at a set pressure or more with the hydrogen gas stored in the compressed hydrogen tank 110 of the compressed hydrogen supply system 100 through the purging process. As a result, the inside of the dehydrogenation reactor 220 is maintained with pure hydrogen gas or in a vacuum state, and the pure hydrogen gas may be generated by a chemical reaction of the reactant inside the dehydrogenation reactor 220.

The hydrogen gas is supplied from the solid hydrogen supply system 200 to the fuel cell 30. In other words, the hydrogen gas generated by the dehydrogenation reactor 220 of the solid hydrogen supply system 200 is supplied to the fuel cell 30 (S330). In this case, the set pressure of the second pressure regulator 280 is set to be larger than the set pressure of the first pressure regulator 120. As a result, the pressure of the hydrogen gas stored in the buffer tank 250 is lowered to the set pressure of the second pressure regulator 280 by the second pressure regulator 280, and then the hydrogen gas stored in the buffer tank 250 is supplied to the fuel cell 30.

When the pressure of the hydrogen gas stored in the buffer tank 250 is lower than a set pressure P2 of the second pressure regulator 280 (S340), the supply of the hydrogen gas supplied from the solid hydrogen supply system 200 to the fuel cell 30 is stopped.

In addition, the hydrogen gas is supplied from the compressed hydrogen supply system 100 to the fuel cell 30 (S350). In this case, the pressure of the hydrogen gas stored in the compressed hydrogen tank 110 is lowered to the set pressure of the first pressure regulator 120, and then the hydrogen gas stored in the compressed hydrogen tank 110 is supplied to the fuel cell 30.

When the pressure of the hydrogen gas stored in the buffer tank 250 is higher than the set pressure of the second pressure regulator 280 by the generation of hydrogen gas in the dehydrogenation reactor 220 (S360), the supply of the hydrogen gas supplied from the compressed hydrogen supply system 100 to the fuel cell 30 is stopped. Instead, the hydrogen gas is supplied from the solid hydrogen supply system 200 to the fuel cell 30 (S330).

As such, when the internal pressure of the buffer tank 250 is higher than the set pressure of the second pressure regulator 280, the hydrogen gas may be supplied from the solid hydrogen supply system 200 to the fuel cell 30, and when the internal pressure of the compressed hydrogen tank 110 is higher than the set pressure of the first pressure regulator 120, the hydrogen gas may be supplied from the compressed hydrogen supply system 100 to the fuel cell 30. In other words, until the reactant of the dehydrogenation reactor 220 is exhausted, and the hydrogen gas of the compressed hydrogen tank 110 is exhausted, the hydrogen gas is supplied to the fuel cell 30 from both the solid hydrogen supply system 200 and the compressed hydrogen supply system 100.

By the hybrid system for generating hydrogen according to an embodiment, the hydrogen gas may be stably supplied from the compressed hydrogen supply system 100 or the solid hydrogen supply system 200 to the fuel cell 30.

In addition, generation of the impurity gas in the dehydrogenation reactor 220 may be minimized through the purging process of the dehydrogenation reactor 220.

Although a preferred embodiment of the present disclosure is described hereinabove, the present disclosure is not limited thereto. Various modifications can be made within the scope of the claims, the detailed description of the present disclosure, and the accompanying drawings, without departing from the scope of the present disclosure as defined by the appended claims.

### DESCRIPTION OF SYMBOLS

10: Detector
20: Controller
30: Fuel cell
100: Compressed hydrogen supply system
110: Compressed hydrogen tank
120: First pressure regulator
130: Booster pump
200: Solid hydrogen supply system
210: Acid aqueous solution tank
220: Dehydrogenation reactor
230: Heat regulation device
231: Reservoir tank
232: Cooling pump
233: Heat exchanger
234: Cooling pipe
240: Purging device
241: First purging pipe
242: Second purging pipe
243: First purging valve
244: Second purging valve
245: Vacuum pump
250: Buffer tank
260: Back pressure regulator
270: Rectification device
280: Second pressure regulator
300: Discharge pipe

What is claimed is:

1. A hybrid system for generating hydrogen comprising:
a compressed hydrogen supply system configured to store compressed hydrogen gas supplied from an external hydrogen charging station, and selectively supply the compressed hydrogen gas to a fuel cell; and
a solid hydrogen supply system configured to generate hydrogen gas by a chemical reaction of a chemical hydride, and selectively supply the generated hydrogen gas to the fuel cell.

2. The hybrid system of claim 1, wherein the compressed hydrogen supply system includes:
at least one compressed hydrogen tank configured to store the compressed hydrogen gas; and
a first pressure regulator provided downstream of the compressed hydrogen tank.

3. The hybrid system of claim 2, wherein the solid hydrogen supply system includes:
an acid aqueous solution tank configured to store an acid aqueous solution;
at least one dehydrogenation reactor configured to store the chemical hydride, and selectively receive the acid aqueous solution stored in the acid aqueous solution tank to generate hydrogen gas; and
a heat regulation device configured to regulate a temperature of the dehydrogenation reactor.

4. The hybrid system of claim 3, wherein the solid hydrogen supply system further includes:
a purging device configured to discharge impurity gas inside the dehydrogenation reactor.

5. The hybrid system of claim 4, wherein the purging device includes:
a first purging pipe configured to fluidly connect the compressed hydrogen tank and the dehydrogenation reactor;
a second purging pipe configured to fluidly connect the dehydrogenation reactor and an outside;
a first purging valve provided in the first purging pipe between the compressed hydrogen tank and the dehydrogenation reactor; and
a second purging valve provided in the second purging pipe downstream of the dehydrogenation reactor.

6. The hybrid system of claim 5, wherein the purging device further includes:
a vacuum pump provided in the second purging pipe downstream of the second purging valve.

7. The hybrid system of claim 3, further comprising:
a buffer tank configured to temporarily store the hydrogen gas generated by the dehydrogenation reactor.

8. The hybrid system of claim 7, further comprising:
a booster pump provided between the buffer tank and the compressed hydrogen tank.

9. The hybrid system of claim 7, wherein the buffer tank is the compressed hydrogen tank of the compressed hydrogen supply system.

10. The hybrid system of claim 7, wherein the solid hydrogen supply system further includes:
a back pressure regulator provided upstream of the buffer tank;
a rectification device for the hydrogen gas provided upstream of the back pressure regulator; and
a second pressure regulator provided downstream of the buffer tank.

11. A hybrid method for generating hydrogen using a compressed hydrogen supply system and a solid hydrogen supply system, the hybrid method comprising:
performing a first mode in which hydrogen gas is supplied from the compressed hydrogen supply system to a fuel cell when a first condition is satisfied;
performing a second mode in which the hydrogen gas is supplied from the solid hydrogen supply system to the fuel cell when a second condition is satisfied; and
performing a third mode in which the hydrogen gas is supplied to the fuel cell while the solid hydrogen supply system and the compressed hydrogen supply system cross each other when a third condition is satisfied.

12. The hybrid method of claim 11, wherein the first condition is satisfied:
when all of reactants of a dehydrogenation reactor of the solid hydrogen supply system are exhausted; or
when an amount of the hydrogen gas stored in a compressed hydrogen tank of the compressed hydrogen supply system is less than a set amount and a storage capacity of the compressed hydrogen tank is equal to or more than a total hydrogen gas generation amount in the solid hydrogen supply system.

13. The hybrid method of claim 11, wherein the second condition is satisfied:
when the hydrogen gas stored in a compressed hydrogen tank of the compressed hydrogen supply system is exhausted;
when an amount of the hydrogen gas generated by the solid hydrogen supply system does not satisfy an amount of hydrogen gas required by the fuel cell; or
when a storage capacity of a buffer tank of the solid hydrogen supply system is equal to or more than a total hydrogen gas generation amount in a dehydrogenation reactor.

14. The hybrid method of claim 11, wherein the third condition is satisfied:
when a flow rate of the hydrogen gas generated by a dehydrogenation reactor of the solid hydrogen supply system deviates from a set range;
when a storage capacity of a buffer tank of the solid hydrogen supply system is less than a total hydrogen gas generation amount by the dehydrogenation reactor of the solid hydrogen supply system; or
when a time required for raising a pressure of the hydrogen gas stored in the buffer tank to be equal to or more than a set pressure of a second pressure regulator is equal to or more than a set time.

15. The hybrid method of claim 11, wherein the first mode includes:
supplying the hydrogen gas stored in a compressed hydrogen tank of the compressed hydrogen supply system to the fuel cell; and
supplying the hydrogen gas from the solid hydrogen supply system to the fuel cell when an internal pressure of the compressed hydrogen tank is less than a set pressure.

16. The hybrid method of claim 11, wherein the second mode includes:
performing a purging process of a dehydrogenation reactor of the solid hydrogen supply system when a purging condition is satisfied;
supplying the hydrogen gas from the solid hydrogen supply system to the fuel cell; and
supplying the hydrogen gas from a compressed hydrogen tank of the compressed hydrogen supply system to the fuel cell when an internal pressure of the dehydrogenation reactor is less than a set pressure.

17. The hybrid method of claim 16, wherein the performing of the purging process includes:
supplying the hydrogen gas stored in the compressed hydrogen tank of the compressed hydrogen supply system to the dehydrogenation reactor of the solid hydrogen supply system; and
discharging a mixed gas having impurity gas of the dehydrogenation reactor and the hydrogen gas to an outside.

18. The hybrid method of claim 11, wherein the third mode includes:
performing a purging process of a dehydrogenation reactor of the solid hydrogen supply system when a purging mode is satisfied;
supplying the hydrogen gas from the solid hydrogen supply system to the fuel cell;
supplying the hydrogen gas stored in a compressed hydrogen tank of the compressed hydrogen supply system to the fuel cell when a pressure of the hydrogen gas stored in a buffer tank of the solid hydrogen supply system is lower than a set pressure of a pressure regulator provided downstream of the buffer tank; and
supplying the hydrogen gas from the solid hydrogen supply system to the fuel cell when the pressure of the hydrogen gas stored in the buffer tank is higher than the set pressure of the pressure regulator provided downstream of the buffer tank.

19. The hybrid method of claim 18, wherein the performing of the purging process includes:
supplying the hydrogen gas stored in the compressed hydrogen tank of the compressed hydrogen supply system to the dehydrogenation reactor of the solid hydrogen supply system; and
discharging a mixed gas having impurity gas of the dehydrogenation reactor and the hydrogen gas to an outside.
